(19) United States
(12) Patent Application Publication
(10) Pub. No.: US 2010/0321392 A1
(43) Pub. Date: Dec. 23, 2010

(54) DEVICE AND METHOD FOR DISPLAYING SYMBOLS ON A MATRIX SCREEN

(75) Inventors: Patrice Kersullec, Vendome (FR); Franck Jeulin, Josnes (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 12/160,491

(22) PCT Filed: Jan. 10, 2007
(86) PCT No.: PCT/EP2007/050217

§ 371 Date: Sep. 3, 2010

(30) Foreign Application Priority Data
Jan. 10, 2006 (FR) 06/00203

(51) Int. Cl. G06T 11/00

(52) U.S. Cl. 345/467

(57) ABSTRACT

The invention relates to a device and a method for displaying symbols on a matrix screen. The device includes means (11) for storing several static areas (2, 3) of the screen (1) and several symbols (4, 5) to be displayed in each area (2, 3), an area table (12) defining the symbol (4, 5) to be displayed for each area (2, 3) and display control means (10) for each point of the matrix depending on the symbol (4, 5) held in the area table (12) and on whether the point belongs to a given area (2, 3) determined by the storage means (11). The method includes, for each point of the screen, in determining the area (2, 3) to which the point belongs using storage means (11); determining the symbol (4, 5) to be displayed using the area table (12); and generating the display of the point.

### CROSS-REFERENCE TO RELATED APPLICATIONS

The present Application is based on International Application No. PCT/EP2007/050217, filed on Jan. 10, 2007, which in turn corresponds to French Application No. 0600203, filed on Jan. 10, 2006, and priority is hereby claimed under 35 USC §119 based on these applications. Each of these applications are hereby incorporated by reference in their entirety into the present application.

### FIELD OF THE INVENTION

The invention relates to a device and a method for displaying symbols on a matrix screen. Many applications require the display of symbols to inform a user. Display panels of railroad stations or airports, the screens of keypad entry gates, some instrument panel equipment on board aircraft and telephony may be cited by way of example.

### BACKGROUND OF THE INVENTION

In a known manner, dedicated screens comprising predetermined areas are used, each area comprising one or more segments depending on the symbols that it is wished to display in the area. For example, displays are known of which each area comprises 7 segments and allow the display of any number in each area. Dedicated screens lack flexibility in their use. It is, for example, not possible to change the size of an area and the number of segments it includes without developing a new screen. In addition, nothing can be displayed in the space between the segments.

To allow evolution in the definition of areas while preserving the same physical screen, it is possible to use a matrix screen which is not dedicated by design to a fixed display type. This type of screen is organized in rows and columns. Each intersection of a row and a column forms a display point. This screen does not comprise a predetermined area. To generate an image on a screen of this type an architecture based on a graphics processor is used, such as used for example in the technologies developed for microcomputing. This type of architecture allows the generation of moving images and is therefore overdesigned for the display of symbols. In addition, this architecture is much more complex than that used to control a dedicated screen. It is consequently much more expensive, its electrical consumption is greater and its reliability lower. The rapid technological evolution of this type of architecture is also a constraint which disrupts maintenance of operational condition in the long term. In fact, it is often impossible to supply spare parts a few years after the development of an architecture.

### SUMMARY OF THE INVENTION

The invention aims to solve the problems cited above by proposing the use of a matrix screen, i.e. a nondedicated screen, without using an architecture employing a graphics processor to display symbols.

To this end, the subject of the invention is a device for displaying symbols on a matrix screen, characterized in that it comprises means for storing several static areas of the screen and several symbols to be displayed in each area, the definition of the symbols being specific to each area, an area table defining the symbol to be displayed for each area and display control means for each point of the matrix depending on the symbol held in the area table and on whether the point belongs to a given area determined by the storage means.

The storage means advantageously comprise a nonvolatile memory such as, for example, a programmable read-only memory (PROM). The use of this type of memory allows the size of the areas and the various symbols that can be displayed in each area to be changed straightforwardly. It is no longer necessary to develop a new physical screen when a new application is developed. It suffices to reprogram or change the nonvolatile memory. Numerous types of read-only memory may be used to implement the invention, such as for example electrically programmable read-only memories, UV-erasable read-only memories, fast programmable read-only memories well known by the name “FlashPROM”.

The subject of the invention is also a method of displaying symbols on a matrix screen, the method using a device such as described above, characterized in that it consists, for each point on the screen, in:
determining the area to which the point belongs using storage means;
determining the symbol to be displayed using the area table; and
generating the display of the point.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWING

The present invention is illustrated by way of example, and not by limitation, in the figures of the accompanying drawings, wherein elements having the same reference numeral designations represent like elements throughout and wherein:

FIG. 1 shows an example of a screen in which the areas have been defined;

FIG. 2 shows symbols displayed on the screen of FIG. 1;

FIG. 3 shows a device according to the invention; and

FIG. 4 shows an example of an area table.

### DETAILED DESCRIPTION OF THE PREFERRED EMBODIMENT

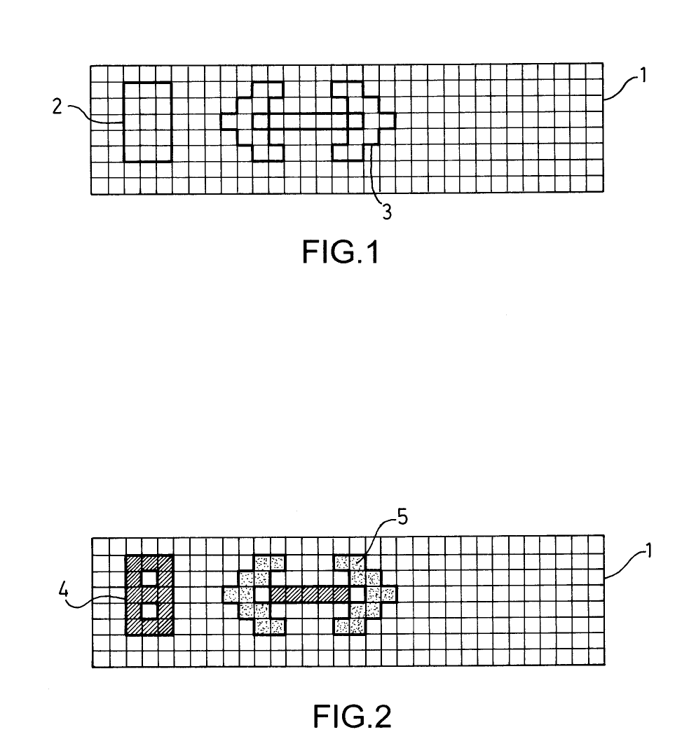

FIG. 1 shows a matrix screen 1 on which two areas 2, 3 and a screen background are shown. The outlines of the areas 2 and 3 are represented by a thick line. An area, according to the invention, is a set of points of the matrix in which the display of an image is desired. An area has a fixed location on the screen, hence the qualifier “static” for the areas defined on the screen. The points of an area may be noncontiguous. The various areas may not overlap. In other words, any one point on the screen belongs to a single area only.

In FIG. 2, two symbols 4 and 5 are shown, each in an area, 2 and 3 respectively.

The screen background also forms an area which also has to be controlled. All the points forming the background may, for example, be “off”.

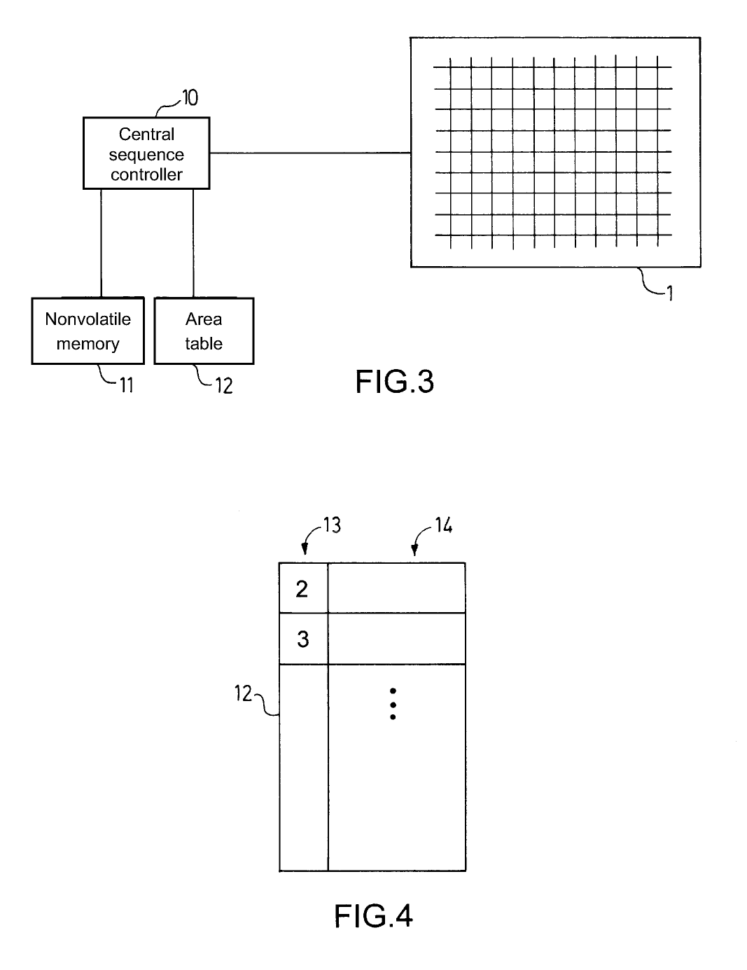

The device shown in FIG. 3 comprises the screen 1, a central sequence controller 10 allowing the display on the screen 1 to be controlled, storage means 11 for storing several areas of the screen and several symbols to be displayed in each area. These storage means advantageously comprise a nonvolatile memory connected to the central sequence controller 10. Nonvolatile memory is understood to mean a memory that preserves the information it contains even in the absence of an electric power supply. This type of memory is often called read-only memory. The central sequence controller 10 may be realized by means of a programmable logic component well known by the name FPGA. It is also possible to realize this sequence controller using discrete components or even by means of a microprocessor. In a preferred variant of the invention the nonvolatile memory is realized using a single fast programmable read-only memory well known by the name FlashPROM.

The device furthermore comprises an area table 12, also connected to the central sequence controller 10. The display of each point of the matrix is defined depending on the symbol held in the area table 12, and on its belonging to a given area, determined by the storage means 11. Its belonging to an area is determined by the position of the current point in the screen matrix.

A display method using the previously described device consists, for each point on the screen 1, in:
determining the area to which the point belongs using storage means 11. This determination is made depending on the position of the current point on the matrix of the screen 1 and is carried out by reading an area of the storage means 11 allocated to a correspondence between the current point and its belonging to an area;
determining the symbol to be displayed using the area table 12, depending on the area the current point belongs to; and
generating the display of the point.

Advantageously, the generation of the display of a point is done using the storage means 11 and the storage of each symbol includes the state of each point of the area considered. The state of a point is, for example, “on” or “off” in the case of a monochrome screen. The state may also define the color of a point in the case of a color screen. More precisely, the address in the storage means 11 where the information about the state of the current point is situated is determined, for example “on” or “off”, depending on the position of the current point on the matrix of the screen 1 and on the data read from the area table 12. In other words, the addressing of the storage means is defined by a point counter for the matrix screen 1, for example for the least significant bits of the addressing, and by the information contained in each row of the area table (2, 3), for example for the most significant bits of the addressing.

The area table 12 contains the symbol held for the area to which the current point belongs. Starting with the symbol read from the area table 12, the information about the state of the current point is looked for in the storage means 11 among the possible symbols stored in the storage means 11.

More precisely, the area table 12 is generated depending on the image that it is desired to see on the screen 1. The area table 12 is advantageously stored in a volatile memory, for example of the random-access type well known by the name of RAM. In the prior art, in order to generate an image on a matrix screen, a volatile memory is used in which a piece of display information for each point of the screen 1 is generated and stored. By contrast, in the invention the area table 12, which only includes one piece of global display information per area, is generated and stored in the volatile memory. The invention allows very marked reduction in the size of the volatile memory used for the display on the screen 1.

FIG. 4 allows the organization of an area table 12 to be better understood. The table 12 is organized so as to ensure the definition of a symbol to be displayed in a given area.

Advantageously, each area is identified by a number and the number of the area to which the current point belongs forms an address 13 in the volatile memory and the piece of data 14 in the volatile memory associated with the address 13 defines a variation of the symbol of the area considered.

The piece of data 14 in the volatile memory provides a complementary address in order to find the states of the points to be displayed. This complementary address, associated with a counter, inside the central sequence controller 10, which points to the position of the current point, allows determination of the address in the storage means 11 where the information about the state of the current point is situated. In FIG. 4 the areas 2 and 3 are represented at address 13. The piece of data 14 provides a held variation of the symbol for the area considered. For example, with a piece of data 14 of 5 bits wide the area considered would be able to display 2⁵, i.e. 32, different symbols. In fact, since this piece of data 14 constitutes a complementary address on the one hand and the memory contains one space of the 32 theoretical spaces for identifying the area it belongs to on the other, in reality 31 different symbols are available per area. If a memory of 8 bits wide is considered, the piece of data 14 contains 3 additional bits allowing the number of symbols to be multiplied by eight, hence 248 different possible symbols in total per area. These 248 symbols are just as many small fields of pixels that may take any value and constitute alphabetic characters, numbers, or even pictograms. The areas are of course independent of each other. The variations of one area may be different from the variations of another area. The definition of the symbols is specific to each area. For example, if the variations of one area allow the display of alphabetic characters, another area may allow the display of numerical characters or even of pictograms. After programming the nonvolatile memory defining the areas and the various symbols to be displayed in an area, a symbol from one area may only be displayed in this area unless of course it has been defined again in another area.

More precisely, a display method using the previously described device consists in concatenating, and repeating for each point of the screen 1, the following operations:
a first page of the storage means 11 is addressed using a position counter for the point on the screen 1;
the area table 12 is addressed by means of the data drawn from the storage means 11 using a position counter for the point on the screen 1;
the storage means 11 are addressed using the data drawn from the area table 12; and
a display state for the point is determined from the data drawn from the storage means 11 at the address obtained from the data from the area table 12.

The addressing of the first page of the storage means 11 consists, for example, of the least significant bits in the addressing of the storage means 11 and the most significant bits of this page, all being at a determined value, for example zero. The addressing of the storage means 11 using the data drawn from the area table 12 constitutes the most significant bits in the addressing of the storage means 11 together with the previously used least significant bits.

Advantageously, a first part alone of the data 14 drawn from the area table 12 suffices to address the storage means 11 and the data drawn from the storage means 11 at the address obtained from the data 14 drawn from the area table 12 is demultiplexed by means of a second part of the data 14 drawn from the area table 12. In this way it is possible to store several symbol variations in the same piece of data in the storage means 11. The data from the area table is, for example, 8 bits wide. As has been previously seen, the first of the data 14 from the area table 12 uses five bits. Three bits of the piece of data 14 therefore remain for demultiplexing the data drawn from the storage means 11.

As has been previously seen, the implementation of the invention allows the use of only a very small-capacity volatile memory, the shape of the areas and of the symbols being stored in a nonvolatile memory. Nonetheless, it is simple to modify the areas and the symbols by reprogramming the nonvolatile memory without changing the electronic components used to implement the device. This is particularly useful, for example, when wanting to provide a display device in various countries using different languages.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A device for displaying symbols on a matrix screen, comprising:
means for storing several static areas of the screen and several symbols able to be displayed in each area, the definition of the symbols being specific to each area, an area table defining the held symbol to be displayed for each area and display control means for each point of the matrix depending on the symbol held in the area table and on whether the point belongs to a given area determined by the storage means.

2. The device as claimed in claim 1, wherein the storage of each symbol comprises the state of each point in the area considered.

3. The device as claimed in claim 1, wherein the addressing of the storage means is defined by a point counter for the matrix screen and by the information contained in each row of the area table.

4. The device as claimed in claim 1, wherein the areas of the screen and the various symbols able to be displayed in each area are stored in a nonvolatile memory.

5. The device as claimed in claim 1, wherein the area table is stored in a volatile memory.

6. The device as claimed in claim 5, wherein each area is identified by a number and the number of the area to which the current point belongs forms an address in the volatile memory and a piece of data in the volatile memory associated with the address defines a variation of the symbol of the area considered.

7. A method of displaying symbols on a matrix screen, the method using a device as claimed in claim 1, comprising, for each point on the screen, in the following steps:
determining the area to which the point belongs using storage means;
determining the held symbol to be displayed using the area table;
generating the display of the point.

8. The method as claimed in claim 7, wherein the generation of the display of the point is carried out with the help of storage means.

9. The display method as claimed in claim 7, wherein:
a first page of the storage means is addressed using a position counter for the point on the screen;
the area table is addressed by means of the data drawn from the storage means using a position counter for the point on the screen;
the storage means are addressed using the data drawn from the area table;
a display state for the point is determined from the data drawn from the storage means at the address obtained from the data from the area table.

10. The display method as claimed in claim 9, wherein a first part alone of the data drawn from the area table suffices to address the storage means and wherein the data drawn from the storage means at the address obtained from the data drawn from the area table is demultiplexed by means of a second part of the data drawn from the area table.

11. The device as claimed in claim 2, wherein the addressing of the storage means is defined by a point counter for the matrix screen and by the information contained in each row of the area table.

12. The device as claimed in claim 2, wherein the areas of the screen and the various symbols able to be displayed in each area are stored in a nonvolatile memory.

13. The device as claimed in claim 3, wherein the areas of the screen and the various symbols able to be displayed in each area are stored in a nonvolatile memory.

14. The device as claimed in claim 2, wherein the area table is stored in a volatile memory.

15. The device as claimed in claim 3, wherein the area table is stored in a volatile memory.

16. The device as claimed in claim 4, wherein the area table is stored in a volatile memory.
